(19) United States
(12) Patent Application Publication
(10) Pub. No.: US 2008/0000159 A1
(43) Pub. Date: Jan. 3, 2008

(54) Zero-Moment Adjuster for Window Assembly

(75) Inventor: Mitchell D. Gilbert, South Beloit, IL (US)

Correspondence Address: BANNER & WITCOFF, LTD., TEN SOUTH WACKER DRIVE, SUITE 3000, CHICAGO, IL, 60606, US

(73) Assignee: NEWELL OPERATING COMPANY, Atlanta, GA (US)

(21) Appl. No.: 11/762,598

(22) Filed: Jun. 13, 2007

Related U.S. Application Data
(60) Provisional application No. 60/813,512, filed on Jun. 14, 2006.

(51) Int. Cl. E05F 11/28

(52) U.S. Cl. 49/345

(57) ABSTRACT

An adjustment mechanism for a casement window assembly includes a rotatable adjuster and a moveable mounting member adapted to be operably connected to a hinge mechanism of the window assembly. The adjuster is non-eccentric, having a cam portion and a non-eccentric rotational axis. The mounting member includes a swivel mount adapted to be pivotably connected to one of the arms of the hinge mechanism and an engagement member connected to the swivel mount. The engagement member includes a plurality of engagement surfaces. Rotation of the adjuster causes the cam portion to engage one or more of the engagement surfaces, thereby exerting a force on the engagement surfaces to move the moveable member, adjusting the position of the swivel mount.

### CROSS-REFERENCE TO RELATED APPLICATIONS

The present application is a continuation-in-part application of and claims the benefit of U.S. Provisional Patent Application No. 60/813,512, which application is incorporated by reference herein and made a part hereof.

### FEDERALLY SPONSORED RESEARCH OR DEVELOPMENT

None.

### TECHNICAL FIELD

The invention relates to casement windows, and more specifically, to an adjustment mechanism for a casement window hinge having a non-eccentric adjuster.

### BACKGROUND OF THE INVENTION

Casement windows and adjustment mechanisms for hinges mounted on the casement windows are known in the art. However, prior casement window hinge adjustment mechanisms often use eccentrically-shaped adjusters that tend to shift over time, due to moments enabled by the eccentric shape. Prior casement window hinge adjusters also suffer from other disadvantages.

The present invention is provided to solve the problems discussed above and other problems, and to provide advantages and aspects not provided by prior casement window hinge adjusters of this type. A full discussion of the features and advantages of the present invention is deferred to the following detailed description, which proceeds with reference to the accompanying drawings.

### SUMMARY OF THE INVENTION

Aspects of the present invention provide an adjustment mechanism for a hinge on a casement window assembly. The casement window assembly includes a hinged window mounted within a jamb frame, a hinge mechanism connected to the jamb frame and the window and having one or more pivotable arms, and an operator coupled to the window to open and close the window. The adjustment mechanism includes a non-eccentric, rotatable adjuster and a moveable mounting member slidably mounted on the window assembly. The adjuster has an actuator and a cam portion. The mounting member includes a swivel mount adapted for pivotable connection to one of the arms of the hinge mechanism to form a connection point, an engagement member having a plurality of engagement surfaces thereon for engaging the adjuster, and a shaft connecting the swivel mount to the engagement member. Rotation of the adjuster causes the cam portion to engage the engagement surfaces, forcing the adjustment member to slide, thereby adjusting the connection point.

According to one aspect of the invention, the hinge mechanism includes a frame coupled to the jamb frame assembly, a shoe slidably mounted on a track on the frame, a sash arm coupled to the window and pivotably coupled to the shoe, and a swivel arm pivotably coupled at a first end to the sash arm and at a second end to the swivel mount.

According to another aspect of the invention, the engagement member has an aperture therein defining the plurality of engagement surfaces, and the adjuster is positioned within the aperture.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a casement window assembly, shown in a closed position;

FIG. 1A is a perspective view of the casement window assembly of FIG. 1A, shown in an open position;

FIG. 2 is a top view of a hinge assembly for a casement window assembly;

FIG. 3 is a perspective view of a portion of a hinge frame and one embodiment of an adjustment mechanism of a hinge assembly;

FIG. 4 is a schematic view of an adjuster for an adjustment assembly, showing forces and moments acting on the adjuster;

FIG. 5 is a schematic view of a prior art eccentric adjuster showing forces and moments acting on the adjuster; and,

FIG. 6 is a schematic view of a second prior art eccentric adjuster showing forces and moments acting on the adjuster.

### DETAILED DESCRIPTION

While this invention is susceptible of embodiments in many different forms, there are shown in the drawings and will herein be described in detail preferred embodiments of the invention with the understanding that the present disclosure is to be considered as an exemplification of the principles of the invention and is not intended to limit the broad aspect of the invention to the embodiments illustrated.

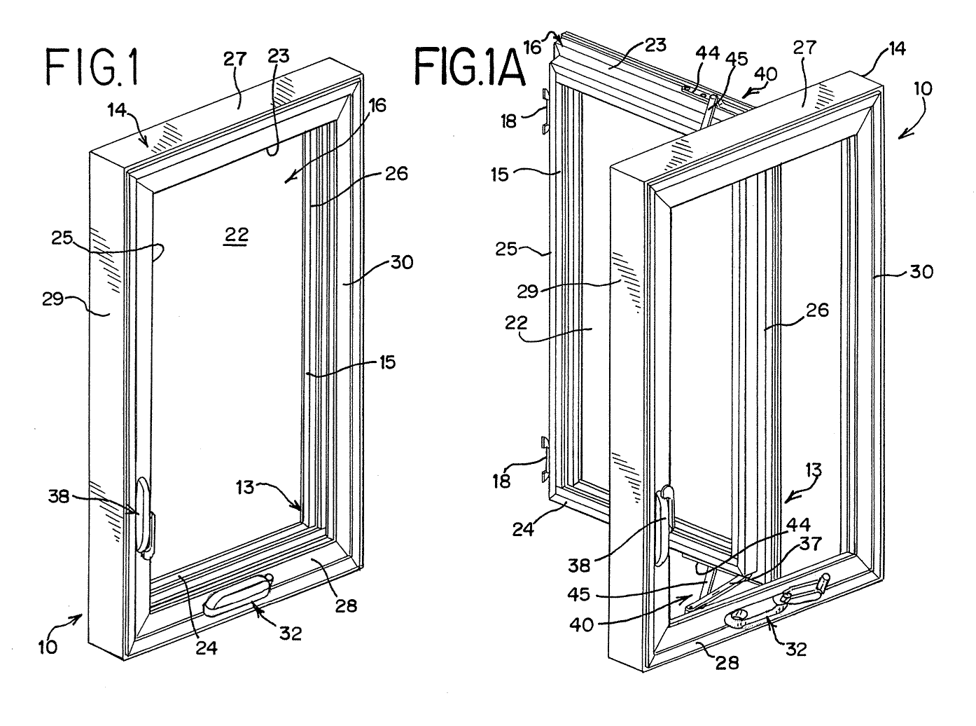

FIG. 1 shows a casement window assembly 10, which includes a jamb frame assembly or window frame 14, and an inner window assembly or window 16. The inner window assembly 16 is formed of a sash frame 15 bordering a window pane 22. The sash frame 15 is formed by two vertical rails 25,26 and two horizontal rails 23,24. The window frame 14 is formed by two vertical jambs 29,30 and two horizontal jambs 27,28. The window 16 and window frame 14 are secured by hinged connections 13, such that the window 16 is moveable between an open and closed configuration relative the frame 14 by pivotal movement of the window 16. FIG. 1 depicts the window assembly 10 with the window 16 pivoted into the closed configuration relative the frame 14. FIG. 1A depicts the window assembly 10 with the window 16 pivoted into the open configuration relative to the frame 14. The window 16 is moved by an operator assembly 32 that includes an actuator (not shown), a housing (not shown) mounted on the bottom jamb 28, and one or more movable operating arms 37 that move back and forth by cranking the actuator 34 to move the window 16. The hinged connection 13 includes a hinge assembly 40 that pivotably supports the window 16. Two locking mechanisms 38 are positioned on one of the vertical jambs 30 and the adjacent vertical rail 26 to secure the jamb 30 to the rail 26, locking the window assembly 10 shut. Two keepers 18 are positioned on the vertical rail 29 adjacent the locking mechanisms 38 for this purpose.

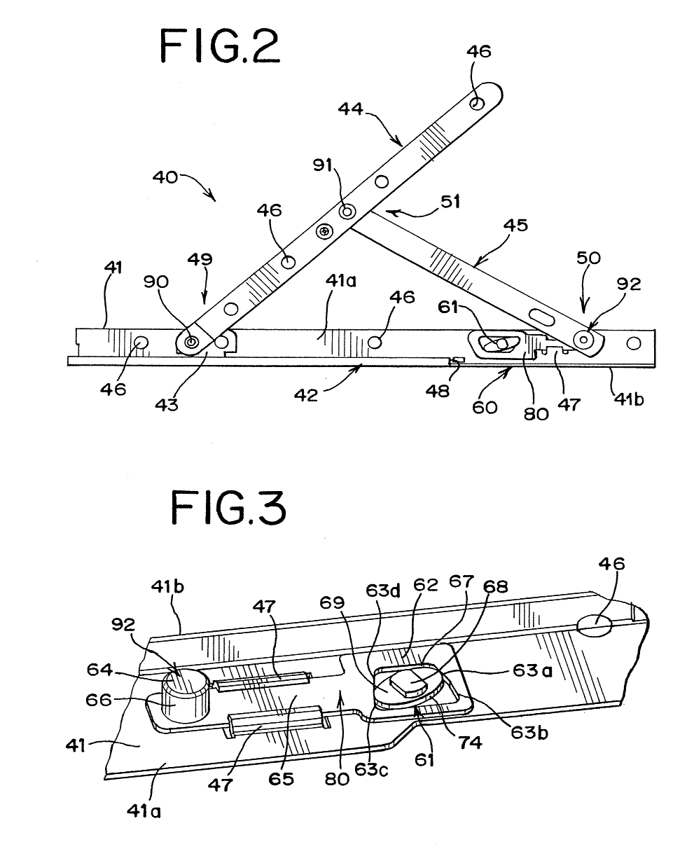

FIG. 2 shows a hinge assembly 40 suitable for use with the present invention. The hinge assembly 40 includes a frame 41, a hinge track 42 extending along the frame 41, a shoe 43 slidably mounted on the track 42, an adjustment mechanism 60 mounted on the frame 41, a sash arm 44 pivotably coupled to the shoe 43, and a swivel arm 45 pivotably coupled to the frame 41 via pivotable coupling to the adjustment mechanism 60. The hinge assembly 40 is generally connected between one of the horizontal jambs 27,28 of the jamb frame assembly 14 to one of the horizontal rails 23,24 of the window 16. As shown in FIG. 1A, the window assembly 10 includes two hinge assemblies 40, located at the top and bottom of the window frame 14, respectively. The sash arm 44 is connected to one of the horizontal rails 23,24 of the window 16 in a lengthwise manner, and the swivel arm 45 is pivotably connected to the sash arm 44, creating an operable connection between the swivel arm 45 and the window 16. The frame, the track, the sash arm 44, the shoe, the swivel arm 45, and some components of the adjustment mechanism are preferably made of stainless steel or another metal, but may be made from another suitable material.

The frame 41 illustrated is an L-shaped metal beam or rail, having two legs 41a,41b arranged at substantially right angles, and is adapted to be fastened to one of the horizontal jambs 27,28 of the jamb frame assembly 14. In the embodiment shown, the horizontal leg 41a is longer than the vertical leg 41b. The frame 41 generally has several fastener holes 46 for attachment to the jamb 27,28 or other components of the hinge assembly 40. Additionally, the horizontal leg 41a preferably has two clamps 47 (FIG. 3) for slidably supporting the adjustment mechanism 60, as discussed below. In other embodiments, the frame 41 can be differently shaped, for example, having a C-shape or a T-shape. Further, the frame 41 may be arranged differently for use with a different type of window assembly 10. For example, the frame 41 may be adapted to be attached to other portions of a window assembly 10, such as the vertical jambs 29,30, if the window 16 swings vertically rather than horizontally. It is understood that the use of the terms “horizontal” and “vertical” are made for reference purposes, and that these orientations may be different when mounted in a vertically-swinging or otherwise different window assembly.

The track 42 runs along a portion of the length of the frame 41, and, in the embodiment shown, is defined by the face of the horizontal leg 41a of the frame 41 and a channel 48 at the tip of the vertical leg 41b. The track 42 may have a stop (not shown) at one or both ends of the track to prevent the shoe 43 from moving out of the track 42. In other embodiments, the track 42 may be differently defined or arranged, such as when the frame 41 or the orientation of the window assembly 10 is arranged differently.

The shoe 43 is slidably mounted on the track 42. In one embodiment, the shoe 43 has a portion (not shown) that is received in the channel 48 of the track 42, allowing the shoe 43 to slide back and forth within the track 42. This arrangement of the shoe 43 and the track 42 is generally known in the art. However, in other embodiments, the shoe 43 and the track 42 may be arranged in a different type of cooperative sliding engagement.

The sash arm 44 is pivotably coupled at one end 49 to the shoe 43, and is connected along its length to one of the horizontal rails 23,24 of the inner window assembly 16, and has several fastener holes 46 for this purpose. In the hinge assembly 40 shown in FIGS. 2 and 3, the sash arm 44 is adapted to be connected to the bottom horizontal rail 24. Because the sash arm 44 is pivotable and connected to the sliding shoe 43, the pivotable end 49 of the sash arm 44 can simultaneously slide and pivot to allow opening and closing of the window 16. In other embodiments, the sash arm 44 may be differently configured.

The swivel arm 45 is pivotably coupled at one end 50 to the adjustment mechanism 60 and pivotably coupled at the other end 51 to the sash arm 44 and to one of the horizontal rails 23, 24 of the window 16. The swivel arm 45 provides an “anchor” for the sash arm 44, because the pivotable connection 92 between the swivel arm 45 and the adjustment mechanism 60 is fixed. As the window 16 opens and closes, the swivel arm 45 pivots with the sash arm 44, but does not slide, thus supporting and anchoring the sash arm 44. In other embodiments, the swivel arm 45 may be differently configured.

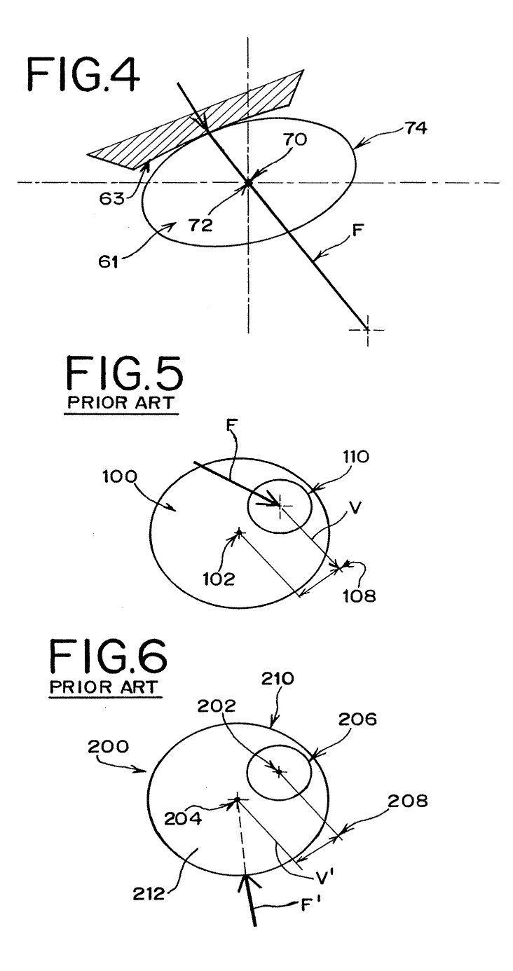

The adjustment mechanism 60 is shown in FIG. 2 and is illustrated in more detail in FIGS. 3-4. The adjustment mechanism 60 generally includes an adjuster 61 and a moveable mounting member 80 mounted on the frame 41. The mounting member 80 includes an engagement member 62 having one or more engagement surfaces 63 thereon for engaging the adjuster 61, a swivel mount 64 for connection to the swivel arm 45, and a shaft 65 connecting the swivel mount 64 to the engagement member 62. In the embodiment illustrated in FIG. 3, the mounting member 80 is slidably supported by the frame 41 via the clamps 47. The shaft 65 of the mounting member 80 is gripped by the clamps 47, allowing the mounting member 80 to slide back and forth within the clamps 47, moving the position of the swivel mount 64. The swivel mount 64, as shown, contains a pin 66 for insertion into a fastener hole of the swivel arm 45, but may alternately be configured to pivotably connect to the swivel arm 45 in a different manner. The engagement member 62 engages the adjuster 61 to move the mounting member 80. In the embodiment shown, the engagement member 62 has an aperture 67 therein, and the engagement surfaces 63 are defined on the inner surfaces of the aperture 67. The adjuster 61 is positioned within the aperture 67 such that rotation of the adjuster 61 causes the adjuster 61 to abut and engage one or more of the engagement surfaces 63 of the engagement member 62, forcing the mounting member 80 to slide within the clamps 47. The structure of the adjuster 61 is described below.

One exemplary embodiment of the adjuster 61 is illustrated in FIGS. 3-4, and contains an actuator 68, a cam portion 69, and a mounting structure (not shown) for rotatably mounting the adjuster 61 to the frame 41, defining a rotational axis 70. The mounting structure may be a riveted connection (not shown) through a hole (not shown) in the frame 41. Alternate means and structure for rotatably mounting the adjuster 61 are possible, including forcing a portion of the adjuster 61 into a hole in the frame 41 to form an interference fit, or by other types of fasteners. An adjuster generally has an engaging portion that receives forces during use, and in prior adjusters, the rotational axis of the adjuster is eccentric with respect to the engaging portion, as described in more detail below. In the adjuster 61 shown in FIGS. 2-4, the cam portion 69 represents the engaging portion, as the outer surfaces of the cam portion 69 are abutted by the engagement surfaces 63 of the mounting member 80 to receive such forces. The adjuster 61 shown in FIGS. 2-4 is non-eccentric, because the rotational axis 70 of the adjuster is not eccentric to the engaging portion (the cam portion 69). In the embodiment shown, because the engaging portion 69 is non-eccentric with respect to the rotational axis 70, the forces applied to the engaging portion 69 by the engagement member 62 act through both the rotational axis 70 and the geometric center 72 of the adjuster 61. This arrangement is also described in more detail below.

The actuator 68 is adapted to allow a user to rotate the adjuster 61 by manipulation of the actuator 68. In the embodiment shown, the actuator 68 is a knob adapted to be engaged for rotation. In other embodiments, the actuator 68 may have a different configuration. For example, the actuator 68 may be a recess, a gripping surface, or a receiver adapted to receive a type of tool, such as a screwdriver or Allen wrench. As shown in FIGS. 2-4, the cam portion 69 of the adjuster 61 operates with a camming action. The engagement surfaces 63 of the mounting member 80 are positioned so that, due to the shape of the cam portion 69, rotation of the adjuster 61 will force the mounting member 80 left and right, as described below. The aperture 67 of the mounting member 80 shown in FIGS. 2 and 3 is generally trapezoidally-shaped, creating this effect.

One common arrangement for connecting the frame 41, the shoe 43, the sash arm 44, and the swivel arm 45 is shown in FIG. 2. The frame 41 is fixedly mounted to the jamb 27,28. The shoe 43 is slidably mounted in the track 42 and slides back and forth along the track 42. The sash arm 44 is pivotably coupled to the shoe 43, forming a pivotable connection 90, and is capable of sliding and pivoting motion. Additionally, the sash arm 44 is adapted to be mounted to the rail 23,24 of the window 16. The swivel arm 45 is pivotably coupled to the sash arm 44, forming a pivotable connection 91, and is also coupled via a pivotable connection 92 to the mounting member 80 via the swivel mount 64, providing an anchor for the sash arm 44. As the window 16 is opened, the shoe 43 slides along the track 42 to the right in FIG. 2, the pivotable connection 91 between the sash arm 44 and swivel arm 45 moves away from the frame 41, and the sash arm 44 and swivel arm 45 pivot accordingly. Conversely, as the window 16 is closed, the shoe 43 slides along the track 42 to the left in FIG. 2, the pivotable connection 91 between the sash arm 44 and swivel arm 45 moves toward the frame 41, and the sash arm 44 and swivel arm 45 pivot accordingly. The hinge mechanism 40 can be adjusted by the adjustment mechanism 60 by moving the swivel mount 64, which forms the connection point 92 between the adjustment mechanism 60 and the swivel arm 45 and also forms an operable connection between the swivel arm 45 and the window frame 14.

Operation of the adjustment mechanism 60 is described with respect to FIG. 3. As shown in FIG. 3, the adjustment mechanism 60 is shifted substantially to the right. In this first position, the cam portion 69 of the adjuster 61 is abutting a first engagement surface 63a of the engagement member 62. Clockwise rotation of the adjuster 61 causes the cam portion 69 to move along the angled first engagement surface 63a to a second engagement surface 63b that is positioned farther from the rotational center of the adjuster 61 than the first engagement surface 63a. Simultaneously, the opposite side of the cam portion 69 moves from abutting a third engagement surface 63c to abutting a fourth engagement surface 63d, which is closer to the rotational center of the adjuster 61 than the third engagement surface 63c. The abutment of the cam portion 69 with the fourth engagement surface 63d pushes the adjustment mechanism 60 to the left, thus shifting the anchor point 92 of the hinge mechanism 40. This allows the hinge mechanism 40 to be shifted for adjustment as necessary, creating optimal functioning of the hinge mechanism 40. It is understood that because the engagement surfaces 63 are all angled in complementary relation to each other, rotation of the adjuster 61 causes gradual and incremental lateral movement of the adjustment mechanism.

Stated another way, the adjuster 61 is rotatable between at least first, second, and third angular positions to adjust the position of the mounting member 80 and the swivel mount 64. When the adjuster 61 is in the first angular position, the cam portion 69 engages a first engagement surface of the engagement member and the swivel mount 64 is in a first position. Rotation of the adjuster 61 from the first angular position to the second angular position causes the cam portion 69 to engage a second engagement surface of the engagement member 62, thereby moving the swivel mount 64 to a second position. Further rotation of the adjuster 61 from the second angular position to the third angular position causes the cam portion 69 to engage a third engagement surface of the engagement member 62, thereby moving the swivel mount 64 to a third position. As described above, the adjustment mechanism 60 is adapted for incremental lateral movement, and can have many more than three adjustment positions.

As described above and illustrated in FIG. 4, the adjuster 61 is non-eccentric, because the rotational axis 70 is not eccentric to the engaging portion (the cam portion 69). Additionally, the cam portion 69 of the adjuster 61 is symmetrical with respect to the rotational axis 70 thereof. Consequently, in the symmetrical, non-eccentric adjuster 61 shown in FIG. 4, the geometric center 72 of the adjuster 61 is located at the rotational axis 70. Because the adjuster 61 is non-eccentric and symmetrical, the forces (F) acting on the outer surface 74 of the adjuster 61 will act through both the geometric center 72 and the rotational axis 70. Because the force vectors pass directly through the rotational axis 70, no moment arm is created. Therefore, the adjuster 61 of the present invention is not prone to slipping and rarely, if ever, needs to be checked and re-adjusted.

The adjustment mechanism 60 provides several advantages over prior adjustment mechanisms. Prior adjusters 100 are generally eccentric, as shown in FIGS. 5-6, which creates several disadvantages. As shown in FIG. 5, these eccentric adjusters 100 are often directly connected to an arm (not shown) in a pivotable arrangement, and have a stud 110 thereon for such connection. The stud 110 forms the engaging portion of the adjuster 100, and is eccentrically located with respect to the rotational axis 102 of the adjuster 100, making the adjuster 100 eccentric. Most forces (F) acting on the stud 110 through the arm have a component vector (V) that does not pass through the rotational axis 102 of the adjuster 100. This force component creates a moment arm 108. The moment arm 108 tends to cause rotation of the adjuster 100, and, as a result, often causes rotational slipping of the adjuster 100 over time. Such slippage moves the hinge mechanism 40 out of optimal position. Because of this, prior eccentric adjusters 100 must be checked and re-adjusted over time. It is understood that other prior eccentric adjusters may have an engaging portion that is centrally located on the adjuster, with a mounting structure eccentrically positioned on the adjuster. In such an embodiment, the adjuster would be eccentric because the axis of rotation defined by the mounting structure would still be eccentric to the engaging portion, and the adjuster would suffer the same disadvantages.

Prior eccentric adjusters 200 have also been used in arrangements where the arm (not shown) is not directly connected to the adjuster 200, such as in the arrangement shown in FIG. 6, and the adjuster 200 instead adjusts the connection point of the swivel arm. Thus, forces are applied to the outer surface 210 of the engaging portion 212 of the adjuster 200. In this arrangement, the adjuster 200 may be mounted by a mounting pin 206, such that the rotational axis 202 of the adjuster 200 is separated from the geometric center 204 of the engaging portion 210. Because the rotational axis 202 is eccentric to the engaging portion 210, the adjuster 200 is considered to be eccentric. Forces (F′) acting on the outer edge of the engaging portion 212 will be directed through the geometric center 204 of the engaging portion 212. However, because the rotational axis 202 is eccentric to the engaging portion 212, most forces acting on the outer edge 206 of the eccentric adjuster 200 will have a component vector (V′) that does not pass through the rotational axis 202 of the adjuster 200. Thus, a moment arm 208 will be created in this arrangement as well.

The non-eccentric adjuster 61 of the adjustment mechanism 60 of the present invention reduces or eliminates this slipping, as described above. The adjustment mechanism 60 provides other advantages as well.

While the specific embodiments have been illustrated and described, numerous modifications come to mind without significantly departing from the spirit of the invention, and the scope of protection is only limited by the scope of the accompanying Claims.

What is claimed is:

1. An adjustment mechanism for a casement window assembly having a hinged window pivotably mounted within a window frame by a hinge mechanism, the hinge mechanism having one or more pivotable arms operably connected to the window, the adjustment mechanism comprising:
a non-eccentric, rotatable adjuster having a cam portion and a rotational axis that is not eccentric to the cam portion; and
a moveable member adapted to be operably connected to the hinge mechanism, comprising:
a swivel mount adapted to be pivotably connected to one of the arms of the hinge mechanism, and
an engagement member connected to the swivel mount, the engagement member having a plurality of engagement surfaces;
wherein rotation of the adjuster causes the cam portion to engage one or more of the engagement surfaces, thereby exerting a force on the engagement surfaces to move the moveable member, adjusting the position of the swivel mount.

2. The adjustment mechanism of claim 1, wherein the cam portion is symmetrical with respect to a rotational axis of the adjuster.

3. The adjustment mechanism of claim 1, wherein the adjuster is rotatable between at least first, second, and third angular positions, wherein when the adjuster is in the first angular position, the cam portion engages a first engagement surface of the engagement member and the swivel mount is in a first position, wherein rotation of the adjuster from the first angular position to the second angular position causes the cam portion to engage a second engagement surface of the engagement member, thereby moving the swivel mount to a second position, and wherein rotation of the adjuster from the second angular position to the third angular position causes the cam portion to engage a third engagement surface of the engagement member, thereby moving the swivel mount to a third position.

4. The adjustment mechanism of claim 1, wherein the movable member is adapted to be slidably mounted to the hinge mechanism.

5. The adjustment mechanism of claim 1, wherein the moveable member further comprises a shaft connecting the swivel mount to the engagement member.

6. The adjustment mechanism of claim 1, wherein the engagement member comprises an aperture, the engagement surfaces located on an inner surface defining the aperture, wherein the adjuster is positioned within the aperture.

7. The adjustment mechanism of claim 1, wherein the adjuster has an actuator adapted to be manipulated by a user to rotate the adjuster.

8. An adjuster for a hinge mechanism for a casement window assembly, the hinge mechanism having at least one operator arm mounted to a track by a mounting member, the adjuster comprising:
a mounting structure adapted to be mounted to the hinge mechanism, the mounting structure defining a rotational axis of the adjuster;
a cam portion having a plurality of engagement surfaces thereon, the rotational axis being non-eccentric to the cam portion, and the cam portion being symmetrical with respect to the rotational axis; and
an actuator connected to the cam portion and adapted to be manipulated by the user to rotate the cam portion about the rotational axis,
wherein upon rotation of the cam portion, the engagement portions are adapted to engage one or more engagement surfaces of the mounting member to move the mounting member and adjust the position of the operator arm.

9. The adjustment mechanism of claim 8, wherein the cam portion is elliptical in shape.

10. The adjustment mechanism of claim 8, wherein the actuator is a knob adapted to be manipulated by a user.

11. The adjustment mechanism of claim 8, wherein the adjuster is adapted to be positioned within an aperture on the engagement member, the aperture having an inner surface defining the engagement surfaces.

12. The adjustment mechanism of claim 8, wherein the mounting structure is a rivet adapted to be received in a mount hole in the hinge track.

13. The adjustment mechanism of claim 8, wherein the adjuster is rotatable between at least first, second, and third angular positions, wherein when the adjuster is in the first angular position, the cam portion is adapted to engage a first engagement surface of the mounting member to place the mounting member in a first position, wherein rotation of the adjuster from the first angular position to the second angular position causes the cam portion to be adapted to engage a second engagement surface of the mounting member, thereby moving the mounting member to a second position, and wherein rotation of the adjuster from the second angular position to the third angular position causes the cam portion to be adapted to engage a third engagement surface of the mounting member, thereby moving the mounting member to a third position.

14. A casement window assembly, comprising:
a window frame;
a hinged window pivotably mounted in the window frame;
a hinge mechanism mounting the window in the window frame, comprising:
a hinge frame mounted on the window frame, the hinge frame having a track,
a shoe slidably mounted on the track,
a sash arm connected to the window and having an end pivotably connected to the shoe, and
a swivel arm having one end pivotably connected to the sash arm and another end pivotably connected to a swivel mount;
an operator assembly comprising an operator handle and one or more moveable arms connected to the window, wherein manipulation of the operator handle causes movement of the arms to open and close the window; and
an adjustment mechanism comprising:
a non-eccentric, rotatable adjuster having a cam portion, the adjuster rotatably mounted on the hinge frame to define a rotational axis that is not eccentric to the cam portion, and
a moveable member slidably mounted on the hinge frame, comprising the swivel mount pivotably connected to the swivel arm, and an engagement member connected to the swivel mount, the engagement member having a plurality of engagement surfaces,
wherein rotation of the adjuster causes the cam portion to engage one or more of the engagement surfaces, thereby exerting a force on the engagement surfaces to move the moveable member, adjusting the position of the swivel mount and adjusting the position of the window within the window frame.

15. The adjustment mechanism of claim 14, wherein the adjuster is rotatable between at least first, second, and third angular positions, wherein when the adjuster is in the first angular position, the cam portion engages a first engagement surface of the engagement member and the swivel mount is in a first position, wherein rotation of the adjuster from the first angular position to the second angular position causes the cam portion to engage a second engagement surface of the engagement member, thereby moving the swivel mount to a second position, and wherein rotation of the adjuster from the second angular position to the third angular position causes the cam portion to engage a third engagement surface of the engagement member, thereby moving the swivel mount to a third position.

16. The adjustment mechanism of claim 14, wherein the moveable member further comprises a shaft connecting the swivel mount to the engagement member.

17. The adjustment mechanism of claim 14, wherein the cam portion is elliptical in shape.

18. The adjustment mechanism of claim 14, wherein the adjuster further comprises a mounting peg mounted on the hinge frame, the mounting peg defining the rotational axis of the adjuster.

19. The adjustment mechanism of claim 18, wherein the cam portion is symmetrical with respect to the rotational axis of the adjuster.

20. The adjustment mechanism of claim 14, wherein the engagement member comprises an aperture, the engagement surfaces located on an inner surface defining the aperture, wherein the adjuster is positioned within the aperture.
